(19) United States
(12) Patent Application Publication
(10) Pub. No.: US 2013/0260284 A1
(43) Pub. Date: Oct. 3, 2013

(54) FUEL CELL SYSTEM

(71) Applicants: Shinichiro Imura, Osaki (JP); Jean-Louis Iaconis, Burnaby (CA); Benjamin Tam, Vancouver (CA)

(72) Inventors: Shinichiro Imura, Osaki (JP); Jean-Louis Iaconis, Burnaby (CA); Benjamin Tam, Vancouver (CA)

(73) Assignees: SOCIETE BIC, Clichy (FR); SANYO Electric Co., Ltd., Osaka (JP)

(21) Appl. No.: 13/435,650

(22) Filed: Mar. 30, 2012

(51) Int. Cl. H01M 8/22; H01M 8/04

(52) U.S. Cl. 429/515

(57) ABSTRACT

A cartridge holder houses a fuel cartridge between a first flat plate and a second flat plate, one each side of which is connected by a joining section, in a detachable manner. A fuel cell module and a second fuel cell module are fixed to the outer surface of the first flat plate and the outer surface of the second flat plate, respectively. As the fuel cartridge is housed in the cartridge holder, the first flat plate and the second flat plate are pressed against and then attached firmly to the outer surfaces of the fuel cartridge.

### BACKGROUND OF THE INVENTION

1. Field of the Invention

The present invention relates to a fuel cell system.

2. Description of the Related Art

A fuel cell system is a device that generates electricity from hydrogen and oxygen so as to obtain highly efficient power generation. A principal feature of the fuel cell system is its capacity for direct power generation which does not undergo a stage of thermal energy or kinetic energy as in the conventional power generation. This presents such advantages as high power generation efficiency despite the small scale setup, reduced emission of nitrogen compounds and the like, and environmental friendliness on account of minimal noise or vibration. In this manner, the fuel cell system is capable of efficiently utilizing chemical energy in its fuel and, as such, environmentally friendly. The fuel cell system is therefore expected as an energy supply system for the twenty-first century and have gained attention as a promising power generation system that can be used in a variety of applications including space applications, automobiles, mobile devices, and large and small scale power generation. Serious technical efforts are being made to develop practical fuel cells.

As mode in which a fuel used in a fuel cell is stored and supplied, the following technology is known. That is, hydrogen is stored in a hydrogen storage alloy and the hydrogen released from this hydrogen storage alloy is supplied to the fuel cell. For example, in one conventional technique, a hydrogen storage alloy tank is designed to be detachable by sliding the hydrogen storage alloy tank relative to the cells in the fuel cell.

Since the release of hydrogen from the hydrogen storage alloy is an endothermic reaction, thus promoting the release of hydrogen. Hence, it is preferable that the heat generated by the fuel cell is used for the heating of the hydrogen storage alloy. However, the conventional fuel cell, where the hydrogen storage alloy tank is detachable, requires that the hydrogen storage alloy tank should be slid relative to the fuel cell in order to insert or remove the hydrogen storage alloy tank into or out of the fuel cell. As a result, a gap is created between the fuel cell and the hydrogen storage alloy tank. Consequently, there is a problem to be solved where the heat generated in the fuel cell cannot be sufficiently transferred to the hydrogen storage alloy tank.

If, on the other hand, the arrangement is made such that the gap between the fuel cell and the hydrogen storage alloy does not occur and therefore the heat generated by the fuel cell can be sufficiently transferred to the hydrogen storage alloy tank, the sliding property of the hydrogen storage alloy will be inferior. For this reason, another problem arises where the loading and removal of the hydrogen storage alloy tank is not done with ease when a user replaces it.

### SUMMARY OF THE INVENTION

The present invention has been made in view of the foregoing problems, and a purpose thereof is to provide a technology by which the heat generated by a fuel cell can be reliably transferred to a hydrogen storage alloy in a fuel cell system where a cartridge containing the hydrogen storage alloy is detachable.

One embodiment of the present invention relates to a fuel cell system. The fuel cell system includes: a fuel cartridge configured to store a hydrogen storage alloy; a holder having a first flat plate and a second flat plate disposed in opposition to the first flat plate, the holder being configured to house the fuel cartridge between the first flat plate and the second flat plate in a detachable manner; and a fuel cell module fixed to an outer surface of the first flat plate and thermally connected to the fuel cartridge via the holder, wherein when the fuel cartridge is placed in the holder, the first flat plate and the second flat plate are so arranged as to be pressed against the fuel cartridge.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a perspective view showing the appearance of a fuel cell system according to a first embodiment of the present invention;

FIG. 2A is a front view of a fuel cell system according to a first embodiment, namely, a view as viewed from arrow X of FIG. 1;

FIG. 2B is a cross-sectional view taken along the line A-A of FIG. 2A;

FIG. 3 is a perspective view showing the appearance of a cartridge holder;

FIG. 4 is a side view showing a cartridge holder where a fuel cartridge is not contained;

FIG. 5 is a schematic cross-sectional view showing a structure of a first fuel cell module included in a fuel cell system according to a first and a second embodiment;

FIG. 6 is a perspective view showing the appearance of a fuel cell system according to a second embodiment of the present invention; and

FIG. 7 is a cross-sectional view taken along the line A-A of FIG. 6.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail in order to avoid unnecessarily obscuring the invention. The drawings show, by way of illustration, specific embodiments in which the invention may be practiced. These embodiments may be combined, other elements may be utilized or structural or logical changes may be made without departing from the scope of the invention. Accordingly, the specification and drawings are to be regarded in an illustrative, rather than a restrictive, sense.

All publications, patents and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used to include one or more than one, independent of any other instances or usages of “at least one” or “one or more”. In this document, the term “or” is used to refer to a nonexclusive or, such that “A, B or C” includes “A only”, “B only”, “C only”, “A and B”, “B and C”, “A and C”, and “A, B and C”, unless otherwise indicated. The terms “above” and “below” are used to describe two different directions in relation to the center of a composite and the terms “upper” and “lower” may be used to describe two different surfaces of a composite.

However, these terms are used merely for ease of description and are not to be understood as fixing the orientation of a fuel cell layer of the described embodiments. In the appended aspects or claims, the terms “first”, “second” and “third”, etc. are used merely as labels, and are not intended to impose numerical requirements on their objects. It shall be understood that any numerical ranges explicitly disclosed in this document shall include any subset of the explicitly disclosed range as if such subset ranges were also explicitly disclosed; for example, a disclosed range of 1-100, or less than or equal to 100 but greater than or equal to 1, shall also include the ranges 1-80, 2-76, or any other numerical range that falls between 1 and 100.

Hereinbelow, various embodiments will be described with reference to the accompanying drawings. Note that in all of the Figures the same reference numerals are given to the same components and the description thereof is omitted as appropriate.

### First Embodiment

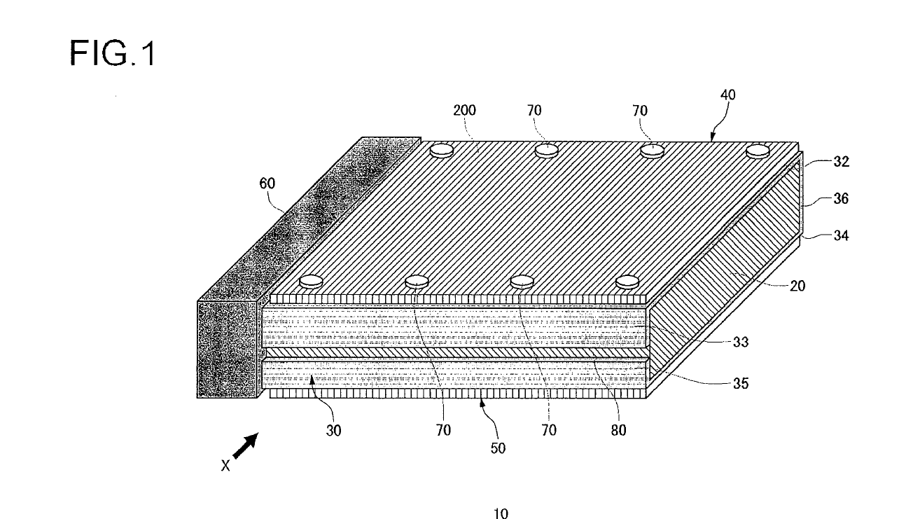

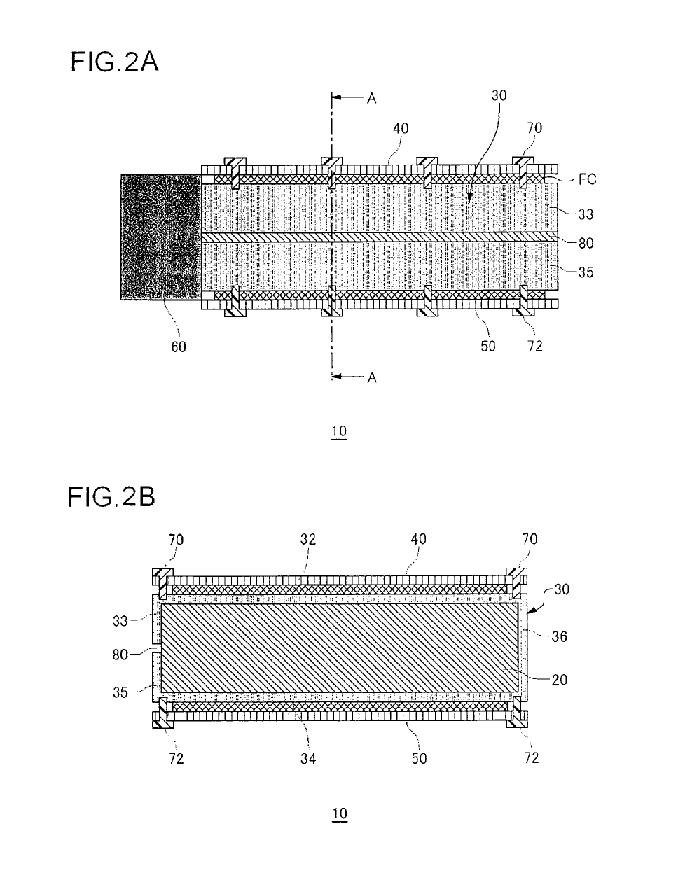

FIG. 1 is a perspective view showing the appearance of a fuel cell system 10 according to a first embodiment of the present invention. FIG. 2A is a front view of the fuel cell system 10 according to the first embodiment, namely, a view as viewed from arrow X of FIG. 1. FIG. 2B is a cross-sectional view taken along the line A-A of FIG. 2A.

The fuel system 10 includes a fuel cartridge 20, a cartridge holder 30, a first fuel cell module 40, a second fuel cell module 50, and a fuel cell supply unit 60.

The fuel cartridge 20 contains a hydrogen storage alloy (metal hydride). The hydrogen storage alloy, which can store hydrogen and can release the stored hydrogen, is rare-earth Mm (misch metal) Ni_{4.32}Mn_{0.18}Al_{0.1}Fe_{0.1}Co_{0.3}, for instance. Note that the hydrogen storage alloy is not limited to a rare-earth -based alloy, but may include a Ti—Mn, Ti—Fe, Ti—Zr, Mg—Ni, or Zr—Mn based alloy, for instance. More specifically, the hydrogen storage alloy may be LaNi₅ alloy, Mg₂Ni alloy, or Ti₁₋ₓCr_{2-y}Mn_{y} (where x=0.1 to 0.3 and y=0 to 1.0) alloy, for instance. The hydrogen storage alloy may be prepared such that the powder of the aforementioned hydrogen storage alloy is mixed with a binder such as polytetrafluoroethylene (PTFE) and this mixture may be formed into pellets compressed and formed by a pressing machine, such as those described in U.S. Pat. No. 7,708,815, titled “COMPOSITE HYDROGEN STORAGE MATERIAL AND METHODS RELATED THERETO”, U.S. Pat. No. 5,662,729, titled “SHAPED BODY OF HYDROGEN ABSORBING AND CONTAINER PACKED WITH HYDROGEN ABSORBING ALLOY” and Japanese Patent 3,286,475, titled “HYDROGEN STORAGE ALLOY COMPACT”, the disclosure of which are herein incorporated by reference in their entirety . These pellets may undergo a sintering process as necessary. The reaction of a hydrogen storage alloy that develops when the hydrogen storage alloy releases hydrogen is an endothermic reaction, whereas the reaction thereof when it absorbs hydrogen is an exothermic reaction. Though the pellets are used as the hydrogen storage alloy in the present embodiments, this should not be considered as limiting. The fuel cartridge may be prismatic, and may include internal structures, such as those described in U.S. Patent Application 2007/0178335, titled “CELLULAR RESERVOIR AND METHODS RELATED THERETO”, the disclosure of which is herein incorporated by reference in its entirety. Such internal structures may be used to promote thermal conductivity throughout the cartridge, or may be used to provide structural support, for example.

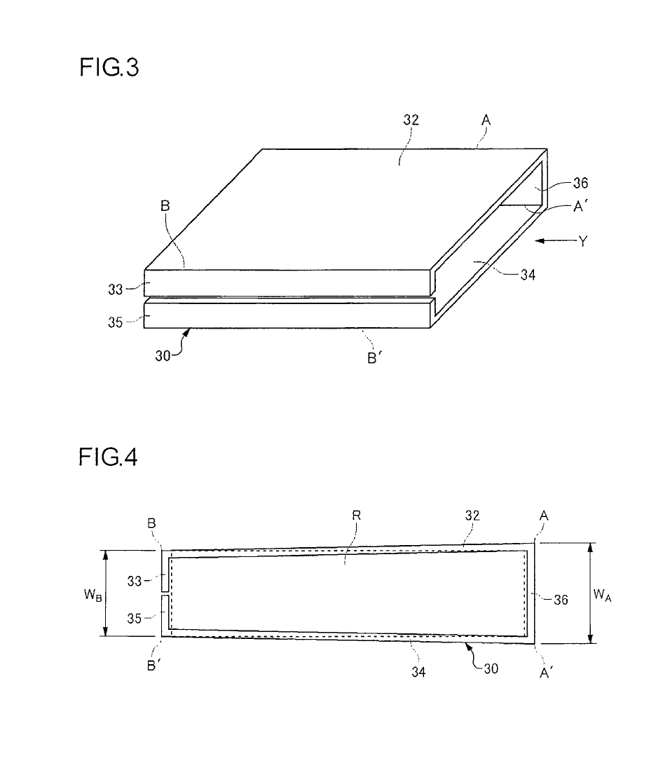

The cartridge holder 30 according to the present embodiment houses the fuel cartridge 20 in a detachable manner. The cartridge holder 30 is formed of material, such as aluminum, copper, or SUS, or any suitable material with good thermal conductivity. In the present embodiment, the cartridge holder 30 includes a first flat plate 32, a second flat plate 34, a joining section 36, a first extending section 33, and a second extending section (see FIG. 3 also).

The first flat plate 32 and the second flat plate 34 are disposed counter to each other. Also, a side A of the first flat plate 32 and a side A′ of the second flat plate 34, which corresponds to the side A, are connected by the joining section 36. The width of the joining section 36 that connects the side A of the first flat plate 32 and the side A′ of the second flat plate 34 is approximately equal to the width of the fuel cartridge 20. Note that the first flat plate 32, the second flat plate 34, the joining section 36, the first extending section 33, and the second extending section 35 are formed integrally with each other. More specifically, a plate-like member is processed by bending itself in a proper manner so as to form the cartridge holder 30.

The fuel cartridge 20 is slid in a direction of arrow Y of FIG. 3, so that the fuel cartridge 20 can be stored in an area (spacing) held between the first flat plate 32 and the second flat plate 34, A hydrogen discharging port (not shown) for supplying hydrogen is provided in the fuel cartridge 20. Also, a hydrogen receiving port (not shown) that connects to the hydrogen discharging outlet is provided in the fuel supply unit 60 described later. With the fuel cartridge 20 housed in the cartridge holder 30, the hydrogen discharging outlet and the hydrogen receiving inlet are connected together and hydrogen flows to the fuel supply unit 60 from the fuel cartridge 20.

The other side of the first flat plate 32 excluding the side A of the first flat plate 32 connecting to the joining section 36 is separated from a side of the second flat plate 34 corresponding to said other side of the first flat plate 32. As a result, the first flat plate 32 is deformable while the side A of the first flat plate 32 is fixed to the joining section 36. FIG. 4 is a side view showing a cartridge holder 30 where the fuel cartridge 20 is not contained. Where the fuel cartridge 20 is not placed inside the cartridge holder 30, a distance WB between the side B of the first flat plate 32 in opposition to the joining section 36 and the side B′ of the second flat plate 34 in opposition thereto is shorter than a distance Wa between the side A and the side A′. In other words, in this state where the cartridge 20 is not placed inside the cartridge holder 30, a part of the first flat plate 32 in opposition to the joining section 36 and a part of the second flat plate 34 in opposition thereto both enter a region R of FIG. 4. Here, the region R indicates a region occupied by the fuel cartridge 20 when the fuel cartridge is placed and contained inside the cartridge holder 30.

When a fuel cartridge is not installed in the cartridge holder, the distance between the first flat plate and the second flat plate is less than the thickness of the cartridge. Consequently, in order to install the cartridge, the plates must be pushed further apart. Once the cartridge is installed, the flat plates will exert an inwards force on the cartridge as they naturally tend towards their original position. As a result, the inner surface of the first flat plate 32 and the outer surface of the fuel cartridge 20 facing said inner surface thereof are attached firmly to each other. Also, the inner surface of the second flat plate 34 and the outer surface of the fuel cartridge 20 facing said inner surface thereof are attached firmly to each other.

Referring to FIG. 4, a gap W_{B}(spacing) between a side B of the first flat plate 32 opposite to the joining section 36 and a side B′ of the second flat plate 34 opposite thereto is not fixed. Thus, at least part of the gap between the first flat plate 32 and the second flat plate 34 can be widened when the fuel cartridge 20 is loaded into or removed from the cartridge holder 30.

The first flat plate 32 includes a first extending section 33 that extends from the side B disposed counter to the side A connected to the joining section 36 wherein the first extending section 33 is bent at side B toward the second flat plate 34. Also, the second flat plate 34 includes a second extending section 35 that extends from the side B′ disposed counter to the side A′ connected to the joining section 36 wherein the second extending section 35 is bent at side B′ toward the first flat plate 32. With the fuel cartridge 20 placed inside the cartridge holder 30, a slit (spacing) (see FIG. 1 and FIGS. 2A and 2B) is formed between the first extending section 33 and the second extending section 35.

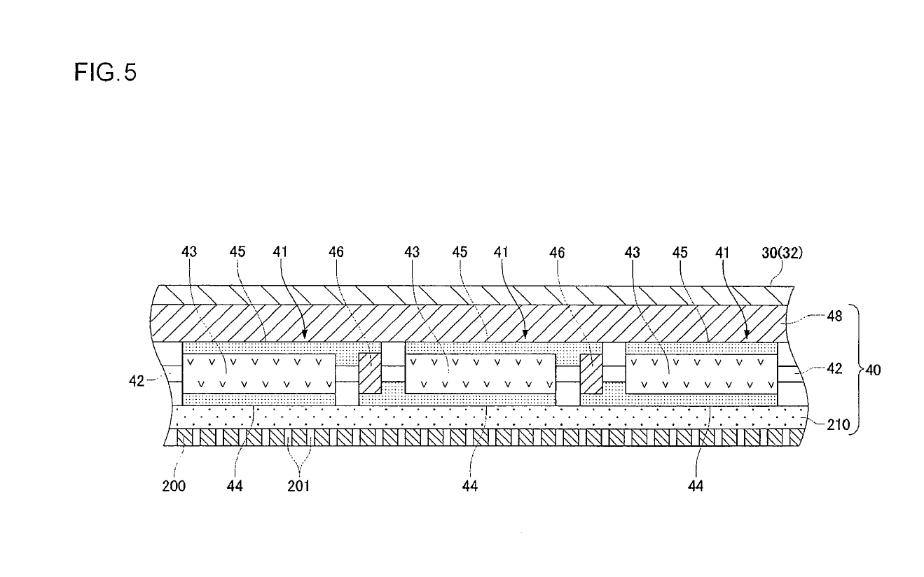

A description is now given of a structure of an exemplary first fuel cell module 40 with reference to FIG. 5. Since the structural components of the second fuel cell module 50 is similar to those of the first fuel cell module, the description thereof is omitted as appropriate. In the following description, a structural component of the second fuel cell module 50 corresponding to that of the first fuel cell module 40 is sometimes denoted with “′(prime mark)” added to the reference numeral of first fuel cell module 40.

The first fuel cell module 40 includes plurality of membrane electrode assemblies (hereinafter referred to as “MEA” or “MEAs” also) 41. A plurality of MEAs, which are disposed inside openings formed in a substrate 42, are disposed in a planar arrangement. The substrate 42 is formed of an insulating material such as polyacrylate, for example.

Each membrane electrode assembly 41 includes an electrolyte membrane 43, a cathode 44 provided on one face of the electrolyte membrane 43, and an anode 45 provided on the other face of the electrolyte membrane 43. The electrolyte membrane 43 is so provided as to fill in the openings provided in the substrate 42. For example, air is supplied to the cathodes 44 as oxidant. Hydrogen is supplied to the anodes 45 as fuel gas. Each cell is structured by a pair of cathode 44 and anode 45 with the electrolyte membrane 43 held between the cathode 44 and the anode 45. Each cell generates electric power through an electrochemical reaction between hydrogen and oxygen in the air. The first fuel cell module 40 according to the present embodiment is formed by a plurality of such cells in a planar arrangement.

A plurality of interconnectors 46 are so provided as to penetrate the substrate 42 between the adjacent membrane electrode assemblies 41. In adjacent MEAs, the cathode 44 of one MEA 41 is provided at one end of the interconnector 46, and the anode 45 of another MEA 41 is provided at the other end of the interconnector 46. The interconnector 46 is formed of a conductive material such as carbon. By employing the above-described structure, the adjacent MEAs 41 are connected in series with each other by the interconnectors 46.

The electrolyte membrane 43, which may show excellent ion conductivity in a moist or humidified condition, functions as an ion-exchange membrane for the transfer of protons between the cathode 44 and the anode 45. The electrolyte membrane 43 is formed of a solid polymer material such as a fluorine-containing polymer or a nonfluorine polymer. The material that can be used is, for instance, a sulfonic acid type perfluorocarbon polymer, a polysulfone resin, a perfluorocarbon polymer having a phosphonic acid group or a carboxylic acid group, or the like. An example of the sulfonic acid type perfluorocarbon polymer is a Nafion ionomer dispersion (made by DuPont: registered trademark) 112. Also, an example of the nonfluorine polymer is a sulfonated aromatic polyether ether ketone, polysulfone or the like.

The cathode 44 and the anode 45 may each provided with ion-exchange material and catalyst particles or carbon particles as the case may be.

Ion-exchange material optionally provided in the cathode 44 and the anode 45 may be used to promote adhesion between the catalyst particles and the electrolyte membrane 30. This ion-exchange material may also play a role of transferring protons between the catalyst particles and the electrolyte membrane 30. The ion-exchange material may be formed of a polymer material similar to that of the electrolyte membrane 43. A catalyst metal may be a single element or an alloy of two or more elements selected from among Sc, Y, Ti, Zr, V, Nb, Fe, Co, Ni, Ru, Rh, Pd, Pt, Os, Ir, lanthanide series element, and actinide series element. Acetylene black, ketjen black, carbon nanotube or the like may be used as the carbon particle when a catalyst is to be supported.

The first fuel cell module 40 is so arranged that a cathode 44 side of the first fuel cell module 40 faces the outside of the fuel cell system 10, namely, it faces a side thereof opposite to the cartridge holder 30. Also, the first fuel cell module 40 may also have a cathode protective layer 200 (see FIG. 1 and FIG. 5) on the cathode side 44 of MEA 41. The cathode protective layer 200 is a member located outermost of the first fuel cell module 40 at the cathode side thereof. The cathode protective layer 200 is formed of a plate-like member, and multiple through-holes 201 penetrating from one main surface to the other main surface are formed in the cathode protective layer 200. These through-holes 201 allows air to easily pass through between the cathode 44 and the outside of the fuel cell. Though the material constituting the cathode protective layer 200 is not limited to any particular one or ones, it may be, alumite-treated aluminum or polyacrylate, for instance. The cathode protective layer may be formed of multiple layers, such as a grille and a porous sheet, for example. Referring to FIG. 5, a gas-liquid separation film 210 may be provided between the cathode protective layer 200 and the cathode 44. The gas-liquid separation film 210 has a function of allowing the air taken in from the outside of the fuel cell or the steam generated in the cathode 44 to pass through and blocking the condensed water adhered to the cathode protective layer 200. A material used for the gas-liquid separation film 210 may be Teflon, for instance. Further examples of cathode protective layers may be found in U.S. Patent Application No. 2009/0081523 entitled “FUEL CELL COVER” and in U.S. Pat. No. 8,080,325, entitled “COVERS FOR ELECTROCHEMICAL CELLS AND RELATED METHODS”, the disclosures of which are herein incorporated by reference in their entireties.

It is to be understood that the fuel cell module illustrated in FIG. 5 is simply an exemplary embodiment. Multiple different fuel cell modules may be utilized in embodiments of this invention, including arrays of electrochemical cells such as fuel cell layers, such as those described in US Patent App. Pub. No. 2011/0003229, filed 27 Feb. 2009 as PCT App. No. PCT/CA/09/00253 and entitled ELECTROCHEMICAL CELL AND MEMBRANES RELATED THERETO, the disclosure of which is herein incorporated by reference in its entirety. Further examples of fuel cell layers are described in U.S. Patent App. Pub. No. 2005/0250004, which was filed on 2 Feb. 2005 as U.S. App. Ser. No. 11/047560 and entitled “ELECTROCHEMICAL CELLS HAVING CURRENT-CARRYING STRUCTURES UNDERLYING ELECTROCHEMICAL REACTION LAYERS”, PCT International App. Pub. No. WO 2011/079377, which was filed on 23 Dec. 2010 and entitled “Fuel Cells and Fuel Cell Components Having Asymmetric Architecture and Methods Thereof”, US Patent Pub. No. 2009/0162722, filed 22 Dec. 2008 and entitled ELECTROCHEMICAL CELL ASSEMBLIES INCLUDING A REGION OF DISCONTINUITY, and PCT International App. Pub. No. WO 2011/079377 entitled “FUEL CELLS AND FUEL CELL COMPONENTS HAVING ASYMMETRIC ARCHITECTURE AND METHODS THEREOF”, the entire disclosures of which are incorporated herein by reference.

Example fuel cell layers are described in the embodiments above; however, it should be understood that the invention could be practiced with any of the fuel cells and fuel cell layers described in any of the patent documents incorporated herein by reference. For clarity, the Figures herein illustrate various embodiments of fuel cell modules that include arrangements of only a relatively small number of fuel cell components; however, the methods of the present invention can be applied to fuel cell layers with a much larger number of fuel cell components.

A fuel flow channel plate 48 may provided on the anode 45 side of the MEA 41. Provided in the fuel flow channel plate 48 is a fuel flow channel (not shown), having a discharge port disposed near the anode 45, which communicates with the fuel supply unit 60. In some embodiments, the fuel cell layer may be directly coupled to a fluid manifold through use of internal support structures, such as configurations description in U.S. Patent Application, 2009/0081493, entitled “FUEL CELL SYSTEMS INCLUDING SPACE-SAVING FLUID PLENUM AND RELATED METHODS”, the disclosure of which is herein incorporated by reference in its entirety.

The first fuel cell module 40 is firmly attached to the outer surface of the first flat plate 32. Accordingly, with the fuel cartridge 20 placed inside the cartridge holder 30, the first fuel cell module 40 and the fuel cartridge 20 may be thermally connected to each other via the cartridge holder 30. In the present embodiment, the first fuel cell module 40 and the first flat plate 32 are fixed together using screws 70. In the present embodiment, the screws 70 to be attached are positioned in a region along a side of the first flat plate 32 near the first extending section 33 and a region along the side A (see FIG. 3) of the first flat plate 32 opposite to the first extending section 33. Although the positions where the screws 70 are to be mounted are not limited to any particular positions, it is generally preferable that no adverse effect be given to MEA 41 and the substrate. For example, the screws 70 may be arranged in such a manner as to penetrate the cathode protective layer 200 only. Since, in this manner, the first fuel cell module 40 is fixed to the first flat plate 32, the first fuel cell module 40 moves in linkage with the movement of the first flat plate 32. In alternate embodiments, the fuel cell modules may be attached to the flat plates via any acceptable means, such as those which may be suited to mass manufacturing. For example, clips, adhesives, or any other suitable means may be used to affix the fuel cell module to the flat plate.

Also, the second fuel cell module 50 is firmly attached to the outer surface of the second flat plate 34. Accordingly, with the fuel cartridge 20 placed inside the cartridge holder 30, the second fuel cell module 50 and the fuel cartridge 20 may be thermally connected to each other via the cartridge holder 30. In the present embodiment, the second fuel cell module 50 and the second flat plate 34 may be fixed together using screws 72; however, it is to be understood that any suitable method may be used to affix the second fuel cell module 50 to the second flat plate 34. The screws 72 to be attached are positioned in a region along a side of the second flat plate 34 near the second extending section 35 and a region along the side A′ (see FIG. 3) of the second flat plate 34 opposite to the second extending section 35. Since, in this manner, the second fuel cell module 50 is fixed to the second flat plate 34, the second fuel cell module 50 moves in linkage with the movement of the second flat plate 34.

The fuel supply unit 60 may include, as principal components, a hydrogen supply passage and a regulator (both not shown). The regulator may or may not be necessary, depending on the pressure at which hydrogen is released from the fuel cartridge. In some instances, a pressure limiter, or a check valve may be used in place of, or in combination with, a pressure regulator. One end of the hydrogen supply passage communicates with an outlet port of the fuel cartridge 20, whereas the other end of the fuel cartridge communicates with the anode of the first fuel cell module 40 and the anode of the second fuel cell module 50 by way of a flow channel provided in the fuel flow channel plate 48. The regulator may be provided at a midway point of the hydrogen supply passage. When hydrogen is released from the hydrogen storage alloy, the regulator reduces the pressure of hydrogen supplied to the first fuel cell module 40 and the second fuel cell module 50. Thereby, an anode catalyst layer of the first fuel cell module 40 and an anode catalyst layer of the fuel cell module 50 are protected.

The following advantageous effects are achieved by employing the fuel cell system 10 according to the present embodiment.

With the fuel cartridge 20 placed and contained in the cartridge holder 30, the inner surface of the first flat plate 32 and the outer surface of the fuel cartridge 20 disposed counter to said inner surface thereof are steadily attached firmly to each other. Also, the inner surface of the second flat plate 34 and the outer surface of the fuel cartridge 20 disposed counter to said inner surface thereof are steadily attached firmly to each other. Thereby, the heat generated by the first fuel cell module 40 which is firmly attached to the outer surface of the first flat plate 32 can be reliably transferred to the hydrogen storage alloy contained in the fuel cartridge 20 by way of the cartridge holder 30. Also, the heat generated by the second fuel cell module 50 which is firmly attached to the outer surface of the second flat plate 34 can be reliably transferred to the hydrogen storage alloy contained in the fuel cartridge 20 by way of the cartridge holder 30. As a result, the release of hydrogen from the hydrogen storage alloy contained in the fuel cell cartridge 20 can be promoted.

The first extending section 33 and the second extending section 35 extend from the first flat plate 32 and the second flat plate 34, respectively. This makes it hard for the fuel cartridge 20 to come off of the cartridge holder 30 when the fuel cartridge 20 is placed inside the cartridge holder 30.

Also, provision of the above-described extending sections (i.e., the first extending section 33 and the second extending section 35) allows the extending sections to determine the position of the fuel cartridge 20. Hence, the hydrogen discharging port provided in the fuel cartridge 20 can be reliably connected to the hydrogen receiving port provided in the fuel supply unit 60. Also, provision of the above-described extending sections allows the extending sections to play the role of guides at cartridge exchange (i.e., at the time of cartridge insertion and ejection).

### Second Embodiment

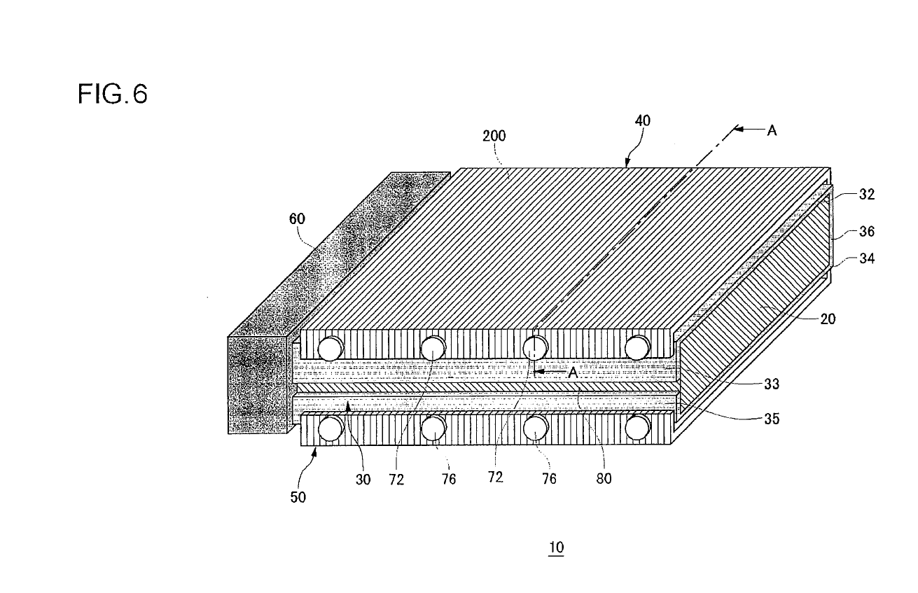

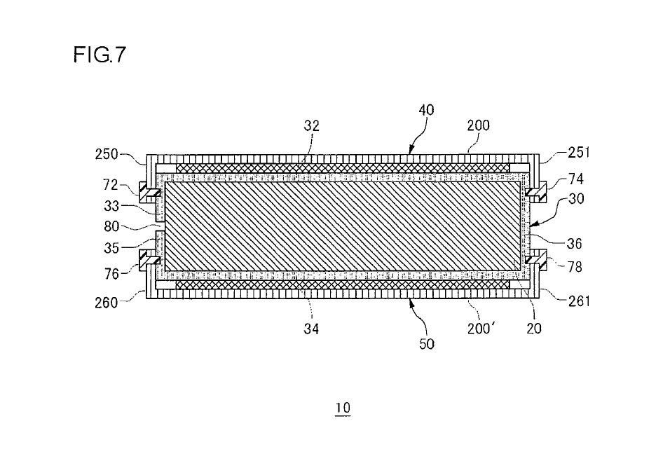

FIG. 6 is a perspective view showing the appearance of a fuel cell system 10 according to a second embodiment of the present invention. FIG. 7 is a cross-sectional view taken along the line A-A of FIG. 6. The fuel cell system 10 according to the second embodiment is basically the same as the fuel cell system 10 according to the first embodiment except that the first fuel cell module 40 and the second fuel cell module 50 are fixed. A description is given hereinbelow of the fuel cell system 10 according to the second embodiment centering around a structure different from that of the first embodiment.

In the second embodiment, the first fuel cell module 40 has a cover 250, bent from a side of a cathode protective layer 200, which extends therefrom in such a manner as to cover at least part of the surface of the first extending section 33. Also, provided opposite to the cover 250 is a cover 251, bent from a side of the cathode protective layer 200, which extends therefrom in such a manner as to cover at least part of the jointing section 36 of the cartridge holder 30. The cover 250 and the first extending section 33 are fixed using screws 72. Also, the cover 251 and the joining section 36 are fixed using screws 74. Thus, the first fuel cell module 40 is secured to the cartridge holder 30.

Similarly, the second fuel cell module 50 has a cover 260, bent from a side of a cathode protective layer 200′, which extends therefrom in such a manner as to cover at least part of the surface of the second extending section 35. Also, provided opposite to the cover 260 is a cover 261, bent from a side of the cathode protective layer 200, which extends therefrom in such a manner as to cover at least part of the jointing section 36 of the cartridge holder 30. The cover 260 and the second extending section 35 are fixed using screws 76. Also, the cover 261 and the joining section 36 are fixed using screws 78. Thus, the second fuel cell module 50 is secured to the cartridge holder 30.

By employing the fuel cell system 10 according to the second embodiment, the same advantageous effects as those attained by the fuel cell system 10 of the first embodiment can be achieved. Also, by employing the fuel cell system 10 according to the second embodiment, the area of cells in the first fuel cell module 40 and the second fuel cell module 50 can be made larger, so that the power output can be increased.

If a fuel flow channel, which connects the regulator of the fuel supply unit 60 and the fuel flow channel plate 48, is to be provided, it is preferable that this fuel flow channel be arranged near the joining section 36 disposed opposite to the slit 80. The deformation amount of the cartridge holder 30 near the joining section is smaller than the deformation amount thereof at a slit 80 side, when the fuel cartridge 20 is inserted into and ejected from the cartridge holder 30. Thus, the chance of damaging the fuel flow channel due to the deformation of the cartridge 30 can be suppressed.

Also, if a control unit for controlling the operation of the fuel cell module and a cooling mechanism for cooling the fuel cell module are to be provided, it is preferable that the control unit and the cooling mechanism be provided opposite to the slit 80. If the control unit and the cooling mechanism are to be fixed, it is preferable that the control unit and the cooling mechanism be fixed to the joining section 36. Thereby, the gap (spacing) between the side B and the side B′ of the cartridge holder 30 can be maintained while the gap therebetween is not fixed.

The present invention is not limited to the above-described embodiments only, and it is understood by those skilled in the art that various modifications such as changes in design may be made based on their knowledge and the embodiments added with such modifications are also within the scope of the present invention.

In the each of the above-described embodiments, the gap is formed between the first extending section 33 and the second extending section 35. In a modification, for example, the first extending section 33 and the second extending section 35 may be joined using an elastic member such as a spring. According to this exemplary modification, the first flat plate 32 and the second flat plate 34 can be more reliably attached firmly to the fuel cartridge 20 with the fuel cartridge 20 placed inside the cartridge holder 30. The above description is intended to be illustrative, and not restrictive. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A fuel cell system, comprising:
a fuel cartridge configured to store a hydrogen storage alloy;
a holder having a first flat plate and a second flat plate disposed in opposition to the first flat plate, the holder being configured to house the fuel cartridge between the first flat plate and the second flat plate in a detachable manner; and
a fuel cell module fixed to an outer surface of the first flat plate and thermally connected to the fuel cartridge via the holder,
wherein when the fuel cartridge is placed in the holder, the first flat plate and the second flat plate are so arranged as to be pressed against the fuel cartridge.

2. A fuel cell system according to claim 1, wherein when the fuel cartridge is loaded into or removed from the holder, at least part of a spacing between the first flat plate and the second flat plate is enlarged.

3. A fuel cell system according to claim 1, further comprising a joining section that joints one side of the first flat plate to one side of the second flat plate,
wherein another side of the first flat plate excluding said one side thereof is separated from another side of the second flat plate corresponding to the another side of the first flat plate.

4. A fuel cell system according to claim 2, further comprising a joining section that joints one side of the first flat plate to one side of the second flat plate,
wherein another side of the first flat plate excluding said one side thereof is separated from another side of the second flat plate corresponding to the another side of the first flat plate.

5. A fuel cell system according to claim 3, further comprising a first extending section that extends from another side of the first flat plate disposed in opposition to said one side thereof, which is connected to the joining section, toward the second flat plate; and
a second extending section that extends from another side of the second flat plate disposed in opposition to said one side thereof, which is connected to the joining section, toward the second flat plate.

6. A fuel cell system according to claim 4, further comprising a first extending section that extends from another side of the first flat plate disposed in opposition to said one side thereof, which is connected to the joining section, toward the second flat plate; and
a second extending section that extends from another side of the second flat plate disposed in opposition to said one side thereof, which is connected to the joining section, toward the second flat plate.
